(19) United States
(12) Patent Application Publication
(10) Pub. No.: US 2015/0012424 A1
(43) Pub. Date: Jan. 8, 2015

(54) Multi-Party Transaction Manager

(71) Applicant: Timo HOTTI, Lohja (FI)

(72) Inventor: Timo HOTTI, Lohja (FI)

(21) Appl. No.: 14/316,376

(22) Filed: Jun. 26, 2014

(30) Foreign Application Priority Data
Jul. 4, 2013 (FI) 20130199

(51) Int. Cl. G06Q 20/10

(52) U.S. Cl. CPC G06Q 20/102
USPC 705/40

(57) ABSTRACT

The invention discloses, inter alia, a computer executable method for managing transactions using a transaction manager process (100) in a network comprising at least one first source (110, 111) of transactions and a plurality of second sources (120, 121, 122) of transactions. The method comprises steps for receiving from a plurality of second sources of transactions (120, 121, 122) at least one new tentative transaction adapted to replace an original actual transaction originated from the first source of transactions (110), wherein at least one data attribute of the at least one transaction of the plurality of new tentative transactions is associable with a data attribute of the original transaction. The method further comprises steps for verifying the data of the new tentative transactions using at least one data verification rule of the transaction manager process (100), establishing at least one threshold event, which must occur in order for the transaction manager (100) to atomically change the status of the plurality of new tentative transactions received from one of the second sources into new actual transactions and the status of the at least one original actual transaction into an expired transaction. Finally, the method receives from at least one first source (110, 111) data triggering the at least one threshold event, atomically changing the statuses of the transactions, and sending at least one of the new actual transactions to the at least one first source (110, 111).

### BACKGROUND

This invention disclosed herein is related to business application services of a multitenant service execution platform. The business services may be any business application services, including but not being limited to electronic commerce systems, e.g. electronic invoicing, purchase ordering and contract lifecycle management. The multitenant platform may be dealing with business transactions where each transaction has a plurality of stakeholding parties, e.g. a sender, a receiver and a service provider and each of the stakeholding parties may be associated with a plurality of users who may need to be associated with the transaction in various contexts.

A multitenant service execution platform should preferably allow competition between a number of service providers for the business of a stakeholder, e.g. a sender or a receiver of a business transaction, e.g. an invoice.

It is an object of the present invention to provide a multitenant data management system that has capabilities e.g. for providing means for competitive bidding of services even at the level of a single business transaction.

### BRIEF DESCRIPTION OF THE INVENTION

An aspect of the invention is a computer executable method for managing transactions using a transaction manager process in a network comprising at least one first source of transactions and a plurality of second sources of transactions. The method may comprise steps for receiving from each of a plurality of second sources of transactions representing competing services at least one set of new tentative transactions adapted to replace an original actual transaction originated from the first source of transactions, wherein at least one data attribute of the at least one transaction of the plurality of new tentative transactions is associable with a data attribute of the original transaction. The method may further comprise steps for verifying the data of the new tentative transactions using at least one data verification rule of the transaction manager process, establishing at least one threshold event, which must occur in order for the transaction manager to atomically change the status of the set of new tentative transactions received from one of the second sources into new set of actual transactions and optionally to change the status of the at least one original actual transaction into an expired transaction. Finally, the method may comprise the step of receiving from at least one first source data triggering the at least one threshold event, atomically changing the statuses of the transactions, and sending at least one of the new actual transactions to the at least one first source.

In an embodiment, the method comprises the step of the transaction manager to sign data of at least one transaction received from at least one second source of transactions.

In an embodiment, the second source of transactions is adapted to receive transactions from the first source of transactions based on a data sharing agreement established between a user representing the first source of transactions and a user representing the second source of transactions.

In an embodiment, the transaction is an invoice, a purchase order or a purchase requisition.

In an embodiment, the second source of transactions is an application service adapted to provide a service based on the transaction received from the first source of transactions.

In an embodiment, the step of verifying the data of the new tentative transactions using at least one data verification rule of the transaction manager process comprises selecting at least one of the applicable verification rules based on the preferences of the at least one first source of transactions.

Another aspect of the present invention is an arrangement comprising at least one server computer. The arrangement is adapted to comprise means for performing at least one combination of steps of a method disclosed herein.

Yet another aspect of the present invention is a computer program product stored in a tangible computer readable storage medium. The product is adapted to comprise computer executable instructions for the purpose of performing at least one combination of steps of a method disclosed herein.

### DRAWINGS

Some preferred embodiments of the invention are described below with references to accompanied figures, where:

FIG. 1 depicts an exemplary arrangement of software processes according to an embodiment of the present invention,

FIGS. 2a-b depict an exemplary high-level data model of data of an embodiment of the present invention and a method for forming such data,

FIGS. 3a-b depict methods for determining stakeholders of a transaction according to an embodiment of the present invention,

FIG. 4 depict an exemplary method of managing business transactions according to a preferred embodiment of the present invention,

FIG. 5 provides an example about business transactions manageable by the preferred embodiment of the present invention,

FIG. 6 shows a conceptual diagram of a computer usable for implementing an embodiment of the present invention.

### DETAILED DESCRIPTION OF PREFERRED EMBODIMENTS

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying”, “associating” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing information in a form readable by a machine (e.g., a computer). For example, a machine-readable medium includes read only memory (“ROM”); random access memory (“RAM”); magnetic disk storage media; optical storage media; flash memory devices; etc.

At least certain embodiments of the present disclosure include one or multiple application programming interfaces in an environment with user interface software interacting with a software application. Various function calls or messages are transferred via the application programming interfaces between the user interface software and software applications. Transferring the function calls or messages may include issuing, initiating, invoking or receiving the function calls or messages. Example application programming interfaces transfer function calls to implement scrolling, gesturing, and animating operations for a device having a display region. An API may also implement functions having parameters, variables, or pointers. An API may receive parameters as disclosed or other combinations of parameters. In addition to the APIs disclosed, other APIs individually or in combination can perform similar functionality as the disclosed APIs.

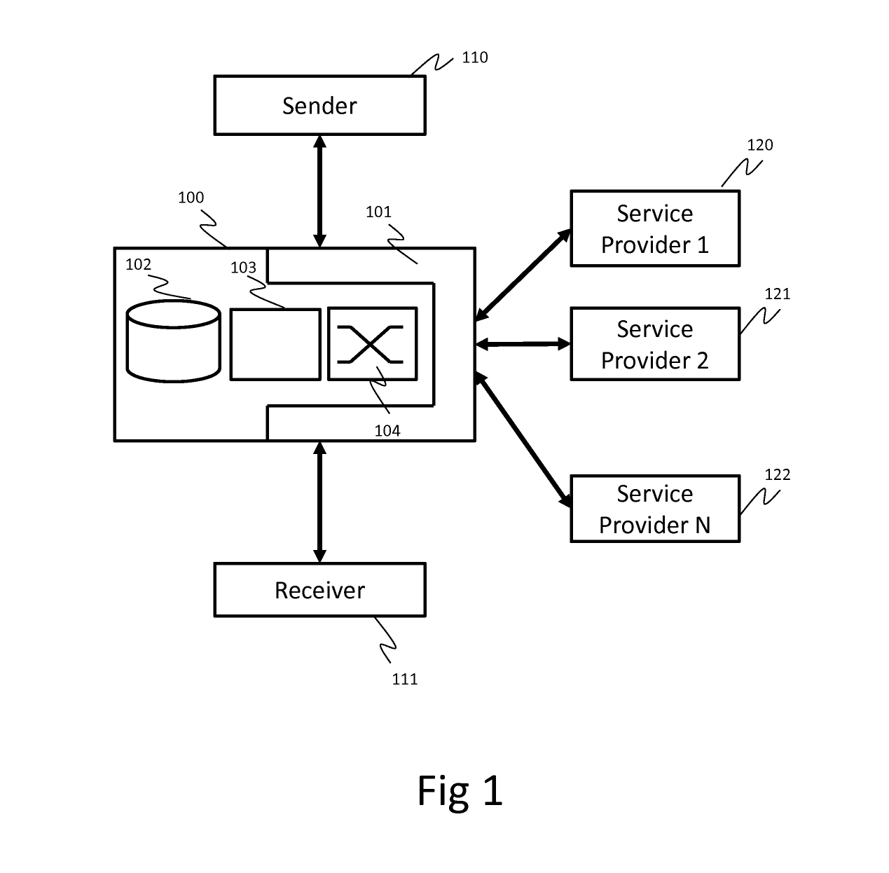

FIG. 1 depicts a computer, service and data communication arrangement according to a preferred embodiment of the present invention.

The transaction manager 100 is a software process executable by a computer processor using data residing in the memory of the computer.

The transaction manager 100 comprises a data communication interface 101 for the purpose of transmitting data to and from other software processes, such as process 110 sending transactions, e.g. invoices and process 111 receiving transactions. In an embodiment, the processes 110 and 111 are called “first sources of transactions”. The transaction manager is also communicatively connected via the interface 101 to software processes 120, 121, 122, that provide services, e.g. invoice financing services, related to the transactions. In an embodiment, the processes 120-122 are called “second sources of transactions”.

In an embodiment, the processes 110 and 111 represent so called primary stakeholders of a transaction and the processes 120-122 represent so called secondary stakeholders of a transaction. The concepts of the primary and secondary stakeholders are discussed later in this chapter.

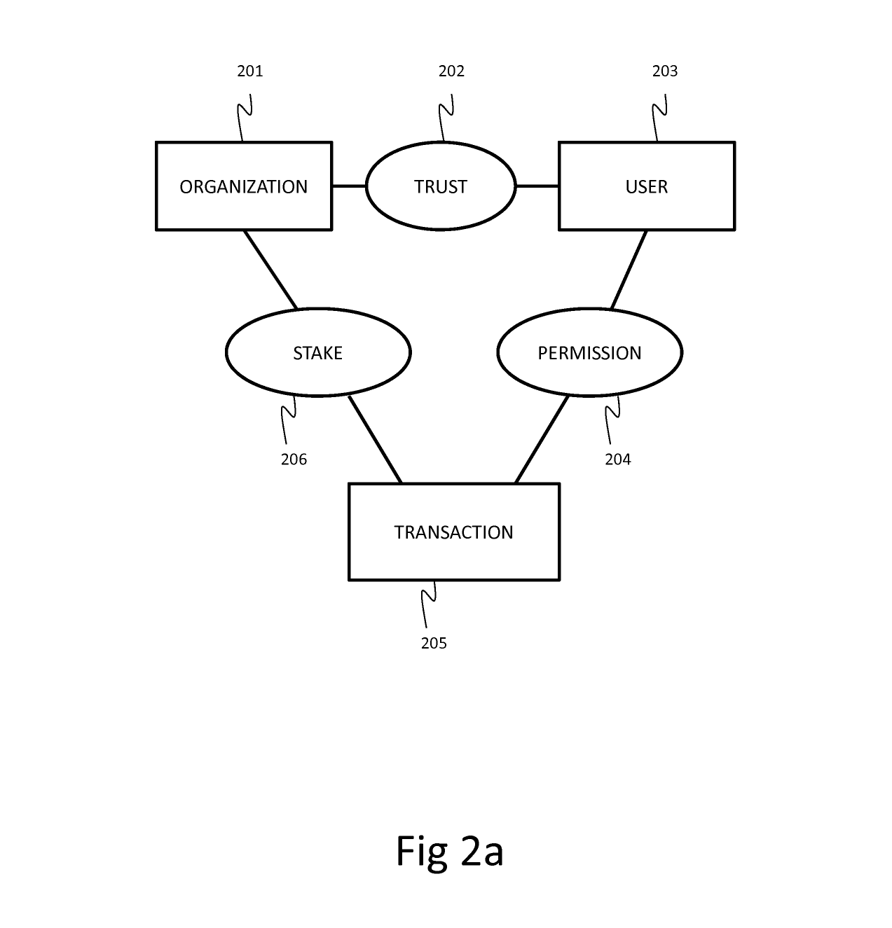

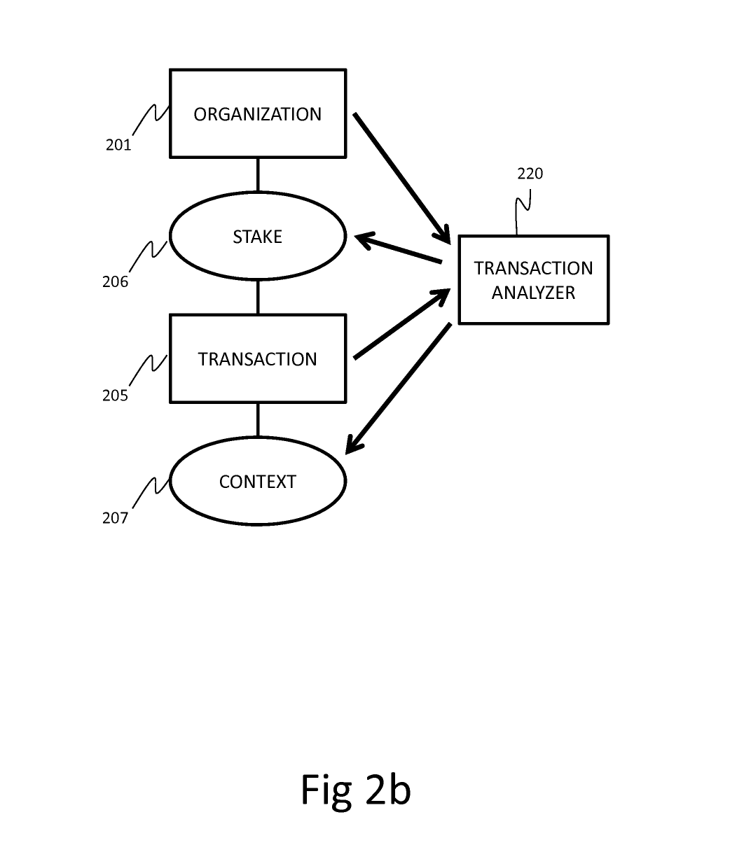

The transaction manager 100 further comprises a data management component 102 that manages the data needed by services comprising the application logic 103 of the transaction manager. An exemplary description of the data managed by the data management component is provided in the FIG. 2a of this detailed description. The application logic 103 is also discussed later in this detailed description. The transaction manager further comprises a transaction routing module that analyses incoming transactions and determines their destination(s). In a preferred embodiment, an incoming transaction, e.g. an invoice, is routed to its intended recipient 111 and to at least one, preferably a plurality of service providers 120, 121, 122.

The software processes of the FIG. 1 may be arranged to be run in a single computer or they may be run in a system comprising a plurality of computers that are communicatively connected with each other using e.g. network communication interfaces.

FIG. 2a depicts an exemplary overview of the data managed by the data management component of the transaction manager (100 in FIG. 1) of an embodiment of the present invention. The data comprises three main entities (objects): organization data 201, user data 203 and transaction data 205. Each organization may act as a stakeholder 206 of a transaction 205, e.g. a business transaction, e.g. an invoice. For example, an organization 201 may be a seller or a buyer of an invoice. An organization may be represented by at least one, preferably by a plurality of users 203 through a trust relationship 202. The trust relationship 202 may specify a context, e.g. a service class comprising a plurality of services, in which the user 203 may represent the organization 201. The representation may occur e.g. via a service that is associated with the context. For example, an organization may trust a user to represent in all invoicing related contexts or in a specific invoicing related context, e.g. financing of invoices. The available contexts may be defined and maintained in the access control services of the data management platform running on computer 102. A context may be associated, e.g. by the operator of the access control services, with any number of services and a service may be associated with multiple different contexts. For example, there may be multiple different services for the context of financing of invoices. The services may be provided by different service providers.

In the embodiment shown, the user 203 is further linked to at least one transaction 205 via an access permission link (relationship) 204. The permission 204 may specify which kind of access the user has to the transaction. The access permission may be e.g. for a read access or for a read/write access. The permission may also contain information about the basis of the permission. One basis for a user to have access to a transaction may for example be that the same user has access rights to the transaction or has accessed the transaction in another system, e.g. an invoice sender system (110 in FIG. 1). Yet another basis for user to have access permission to a transaction may be e.g. a rule that has been defined in the established trust relationship. For example, the rule may specify that the user, to whom the trust has been granted, has access permission to the same transactions to which the grantor of the trust has access permission.

The data objects mentioned herein may be implemented in the memory of a computer e.g. as data objects or in any other manner accessible and modifiable by a processor of the computer. The functional components of various embodiments described herein, including steps of various methods, may be implemented as instructions executable in the memory of a computer by the processor of the computer.

In a preferred embodiment, the data model of FIG. 2a is used for user 203 access authorization purposes in a multitenant system comprising a plurality of organizations 201 and a plurality of transactions 205, each transaction having at least one, preferably multiple, organizations as stakeholders. If a user 203 wants to represent an organization in a process involving a transaction, the user 203 needs to have established a trust link (relationship) 202 with the organization 201 either directly or via another user 203 who already has established a trust relationship 202 with the organization. Additionally, the user needs to have a permission link 204 to the transaction 205 and the organization 201 must be a stakeholder 206 of the transaction 205.

The transactions imported to the transaction collection 205 of the data management component (102 in FIG. 1) are analyzed using for example an arrangement shown in FIG. 2b. The analysis is needed to establish the stakeholder relationships 206 between organizations 201 and imported transactions 205. The analysis is performed using a transaction analyzer component 220. The analyzer inspects the data of the imported transaction and determines based on its findings, which organizations are stakeholders of the transaction. The inspected data may comprise the content of the transaction and/or meta-data, including routing data usable by the router 210, related to the transaction. The content of the transaction may contain e.g. the name and address information of the sender (seller) and recipient (buyer) of an invoice. In an embodiment, a specific combination of information may identify two stakeholders. E.g. the seller name specifies the seller but the associated address or other contact information specifies the finance company who performs the invoicing on behalf of the seller. In such case, both the seller and the finance company should be added as stakeholders of the transaction. The meta-data of the transaction may comprise e.g. routing information of the transaction in a transaction routing network or some data related to an activity performed on the transaction. In addition to establishing the stakeholder relationships 206 between organizations 201 and transactions 205, the transaction analysis process performed e.g. by the transaction analyzer component 220 determines the possible usage contexts 207 of the transaction 205. The usage context may e.g. indicate, which (kind of) services may be provided for the transaction. The process of determining the possible usage context may utilize e.g. the content of the transaction 205 or any properties of the stakeholder organizations 201 as input. For example, a usage context may require a certain property from the transaction, a certain capability from the application services of the sender and/or a certain capability from application services of the receiver. To exemplify further, in order to be able to provide a factoring service to an invoice, the receiver of the invoice must be able to receive the invoice from a party other than the original sender. The “factoring” context can thus be associated with an invoice only, if the receiver meets the interface criteria set for factoring services.

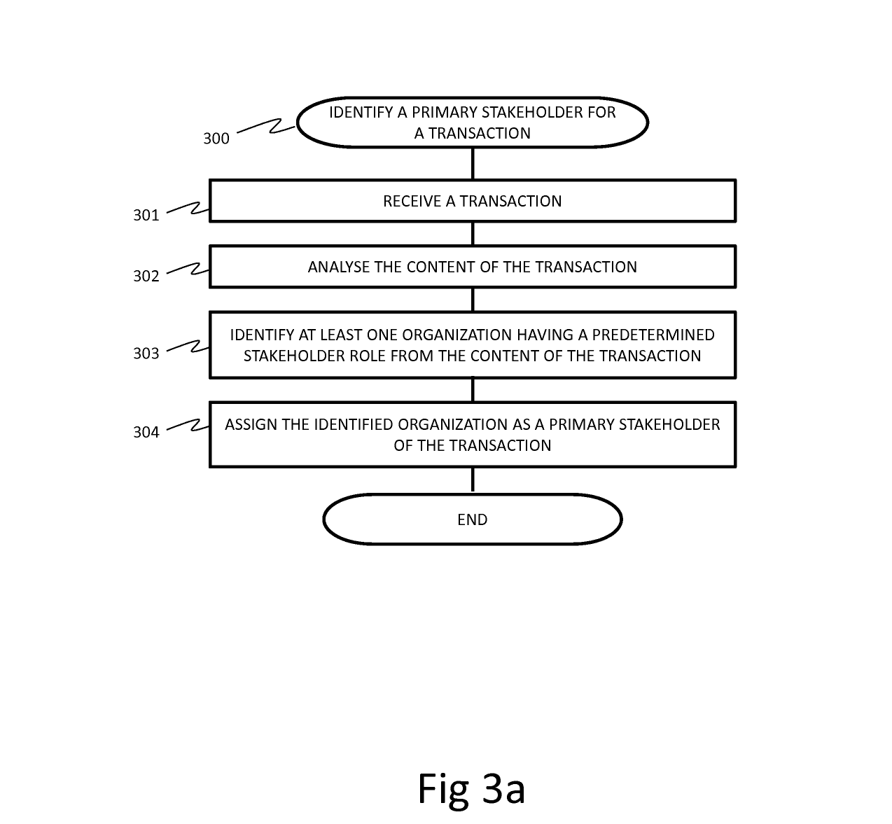

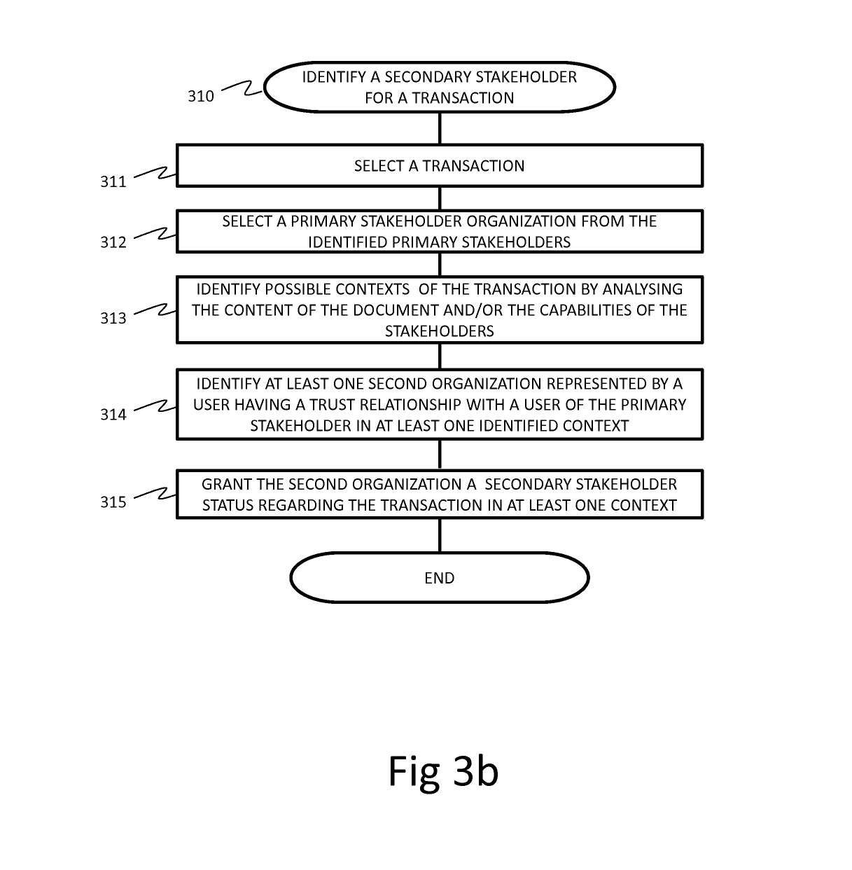

FIG. 3a shows a flow diagram about identifying 300 a primary stakeholder of a transaction. In step 301, a transaction is received into the database residing in the storage 103 of the transaction management system 100. The transaction may have any suitable format comprising structured and/or unstructured data. The structured data may be e.g. XML data and the unstructured data may be e.g. image data. In step 302, the content of the transaction is analyzed. If the content is in an unstructured format, the content is converted into a structured format so that individual data items of the transaction may be assigned a semantic meaning. Next, in step 303, at least one organization (201 in FIG. 2a) is identified from the content of the transaction to have a pre-determined primary stakeholder role in the transaction. Such pre-determined role may be e.g. a sender or a receiver of an invoice. In an embodiment, the primary stakeholder identification process must identify at least two primary stakeholders for the transaction. Failure to do so marks the transaction as an erroneous transaction that requires e.g. manual resolution. The identified organizations must be available in the organization data collection of the database of the data storage 103. Finally, in step 304, the identified organizations are assigned as primary stakeholders of the transaction.

In a preferred embodiment, the transaction may also have at least one, preferably multiple secondary stakeholders, e.g. a legal entity, e.g. a company, that is allowed to provide a service related to the transaction. In a preferred embodiment, an organization is a secondary stakeholder to a transaction, if a trust relationship exists between a user representing the primary stakeholder of the transaction and a user representing the second organization. In a preferred embodiment, a data sharing agreement data object between the primary and secondary stakeholders is formed based on the trust relationship between the users. The flow chart of FIG. 3b depicts an exemplary method 310 of identifying such secondary stakeholders. In step 311, a transaction is selected for the identification process. The transaction may be e.g. a transaction that was received in the process described in FIG. 3a. Next, in step 312, a previously identified primary stakeholder is selected from the list of primary stakeholders of the transaction. Next, in step 313, possible contexts (e.g. services available to the transaction) of the transaction are identified. In a preferred embodiment, the identification process inspects the content of the transaction and/or the capabilities of the already known stakeholders of the transaction. For example, a transaction may belong to an invoice financing (factoring) service context, if the transaction can be interpreted as an electronic invoice, i.e. it is already one or it can be translated into one, and the receiver of the transaction, i.e. a primary stakeholder, is capable of receiving and approving electronic invoices. In step 314, at least one second organization is identified, whose representative user, i.e. user who is allowed to represent the organization, has a data sharing agreement based on a trust relationship with the representative user of a primary stakeholder in at least one identified context. If the data sharing agreement comprises or is associated with data selection criteria, the method checks that the transaction meets those criteria. Those transactions that fail to meet the criteria are ignored. Finally, in step 315, the second organization is granted a secondary stakeholder status to the transaction in the context specified in the data sharing agreement. For example, an organization providing invoice financing services may be granted a secondary stakeholder status to the transaction in the context of financing of electronic invoices. In a preferred embodiment, the secondary stakeholder status is valid as long as the chain of trust between the primary and secondary stakeholder organizations involving the trust relationship is a valid one.

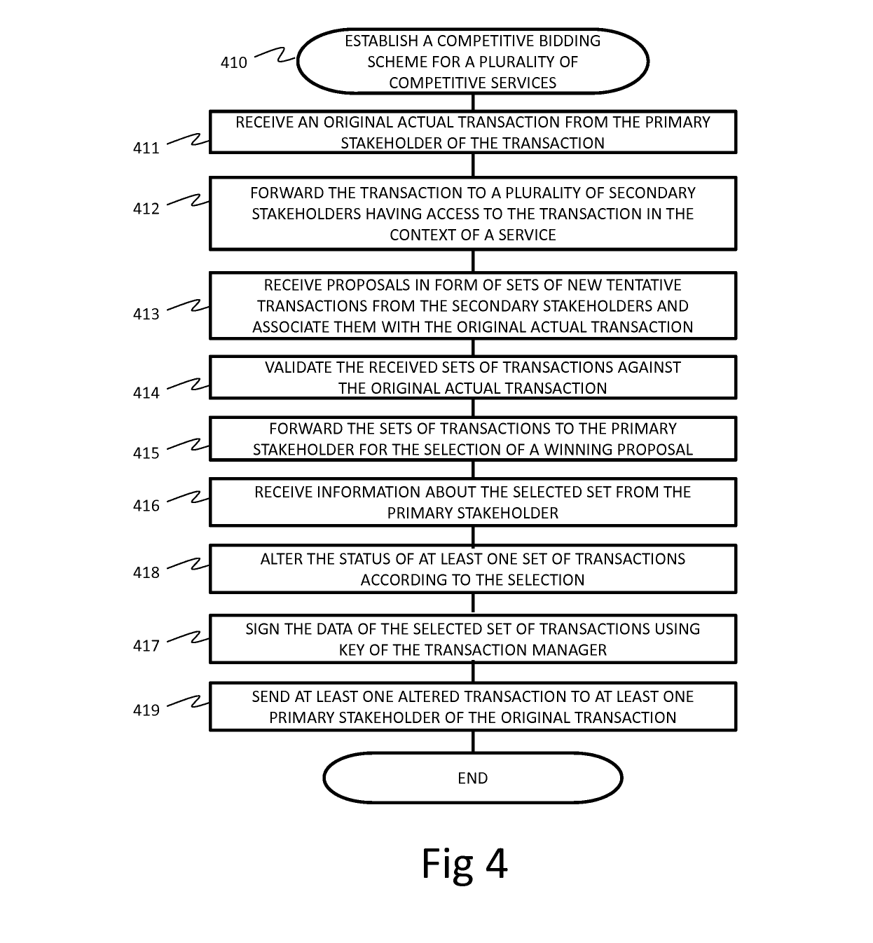

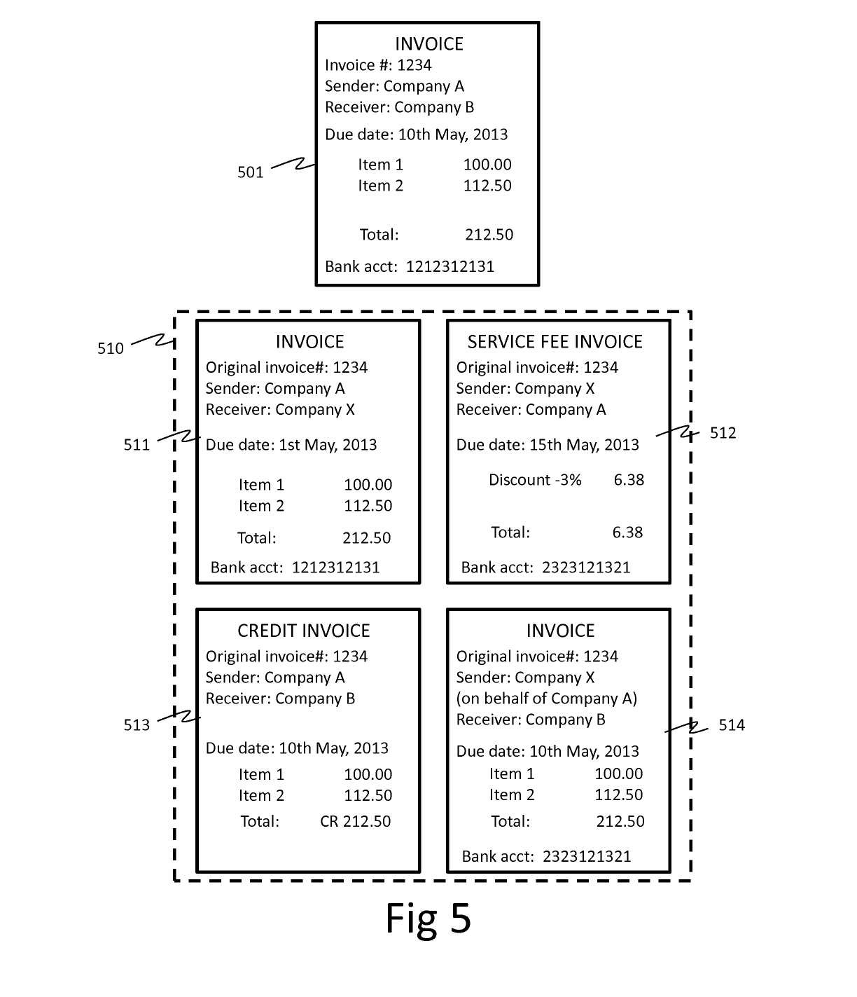

FIG. 4 depicts a method 410 for establishing, by the business transaction manager of an embodiment of the present invention, a competitive bidding scheme for a plurality of competitive services. In step 411, the transaction manager (100 in FIG. 1) receives an original actual transaction from a primary stakeholder (110 in FIG. 1) of the transaction. The transaction may be e.g. an invoice and the primary stakeholder may be the sender of the invoice. In step 412, the transaction manager identifies the transaction as one that has multiple secondary stakeholders (120-122 in FIG. 1) in the context of a service and forwards the transaction to those stakeholders. The secondary stakeholders may be application service providers who each have established a trust relationship, e.g. a data sharing agreement, with the sender. In a preferred embodiment, the data sharing agreement is established between a user representing, via a trust relationship (202 in FIG. 2a), the primary stakeholder and another user representing, similarly via a trust relationship, the secondary stakeholder in the context of the service. The data sharing agreement allows the service providers to have access to at least some transactions of the sender. The service may be e.g. a financing service of an invoice. While forwarding the transaction to the secondary stakeholders, the transaction manager advantageously indicates that the service requested from the service providers is subject to competitive bidding and that the data produced by the service providers is of tentative nature and subject to the primary stakeholders's approval. In step 413, the transaction manager receives such tentative data, e.g. proposals in form of sets of new tentative transactions from the secondary stakeholders. The transaction manager then associates the sets of new tentative transactions with the original actual transaction. The primary stakeholder of the original actual transaction may also be a primary stakeholder of the sets of tentative transactions. Next, in step 414, the transaction manager validates, using e.g. a set of rules or application logic specific to the service, that each of the received sets of tentative transactions is a valid replacement of the original actual transaction. (An example of an actual transaction and a replacing set of transactions is described in the FIG. 5 of this detailed description of preferred embodiments.) In an embodiment, there may be multiple different sets of validation rules available for the validation. The set of rules to be used in the validation may be selected e.g. according to the preferences and/or capabilities of the sender or receiver of the original transaction. This way the sender or receiver of the original transaction and/or the transaction manager may ensure that the set of replacing transactions is compatible with the requirements of the system(s) that process(es) the replacing transactions. In step 415, the validated sets of transactions, or some summary data constructed from each set of transactions e.g. by the transaction manager, are forwarded to the sender of the original actual transaction, e.g. to the sender of an invoice. The transaction manager then receives 416 information from the sender about the selected set of transactions to the transaction manager. This is a threshold event that is required by the transaction manager to perform a status alteration action on a set of new tentative transactions. In a preferred embodiment, the transaction manager then alters 417 the status of at least the selected set of tentative transactions to new actual transactions. The transaction manager also signs 418 the selected set of transactions e.g. with its own private key to indicate that the data has passed its own validation routines (step 415) and that the transaction manager has received authorization from the primary stakeholder to replace the original actual transaction with the set of new transactions. Finally, in step 419, the transaction manager sends the altered signed transactions to their intended recipients, typically the primary stakeholders of the original transaction.

In an embodiment, there may be more than one threshold event required in step 416 to perform the status alteration of step 417. The additional threshold event from another stakeholder, e.g. receiver, of the original transaction may be required e.g. by the selected service provider. For example, the alteration of the status of the selected set of new transactions may proceed only when the recipient of the original transaction approves the original transaction, e.g. an invoice. This way, the financing service provider may limit its financing services only to approved invoices.

FIG. 5 depicts an exemplary original actual transaction 501 and a set 510 of new tentative transactions (511, 512, 513, 514) that may replace the original actual transaction. The original transaction (invoice) has been sent from seller (“Company A”) to buyer (“Company B”). The new set of tentative transactions 510 is created by a financing service provider (“Company X”). In a preferred embodiment of the invention, there are multiple service providers bidding for the financing of the original invoice. Thus there advantageously are a plurality of sets 510 of tentative transactions, of which one may, upon selection of the sender of the original invoice, become the new set of actual transactions that replaces the original actual transaction.

In the shown example, the new set of transactions has four new invoices.

The invoice 511 is sent by the transaction manager to the financing provider who has agreed to pay the invoice to the sender on an earlier due date in exchange for a discount.

The invoice 512 is a service fee invoice that the transaction manager sends to the sender of the original invoice to allow the service provider charge for its service. The service fee is about the discount that the sender of the original invoice sender grants to the service provider in exchange for earlier payment of the invoice.

The invoice 513 is a credit invoice that the transaction manager sends to the recipient of the original invoice. The credit invoice of the original invoice is needed because the recipient must pay the new invoice to the financing service provider instead of the original sender. The new debit invoice to the recipient is the invoice 514. This one has new sender and payment (bank account) information.

Each of the new tentative invoices has a reference to the original invoice 501 in form of an “Original invoice#” data field. Additionally, there is an internal status attribute (not shown in figure) that indicates, whether the new invoices are tentative invoices or actual invoices. The “original invoice#” data field may be used in the step 414 (FIG. 4) when validating the data of the set of new transactions 510 against the data of the original transaction 501.

In an embodiment, there may be multiple different possible sets of data 510 that the service providers may create. The transaction manager 100 may comprise information about which set is allowable e.g. for each sender or receiver or combination of them. The service providers (120-122 in FIG. 1) may query this information from the transaction manager.

In an embodiment, data coming from different sources may have different formats. For example, in the case of electronic invoices, there are multiple standard formats in active use. The transaction manager needs to translate those formats into one that it can use for its own operations, e.g. for the validation of the transaction data.

In a preferred embodiment of the invention, the invoices of the sets 510 of new invoices are signed by the transaction manager using the private key of the transaction manager. This way the transaction manager may act as a trusted partner with the senders and receivers. No additional trust relationships are needed e.g. between the financing service providers and the receivers of the invoices. It is sufficient, that the receiver of the invoice trusts the data that comes from the transaction manager. It can do so if it trusts that the transaction manager is able to sufficiently validate the data that the transaction manager receives from the service providers.

Furthermore, in a preferred embodiment, the transaction manager is adapted to change, upon a signal received from e.g. the sender of the original invoice, the statuses of the transactions of the selected set from “tentative” to “actual” as an atomic operation that either succeeds as a whole or fails as a whole. The status of the original transaction may be altered as part of the same operation.

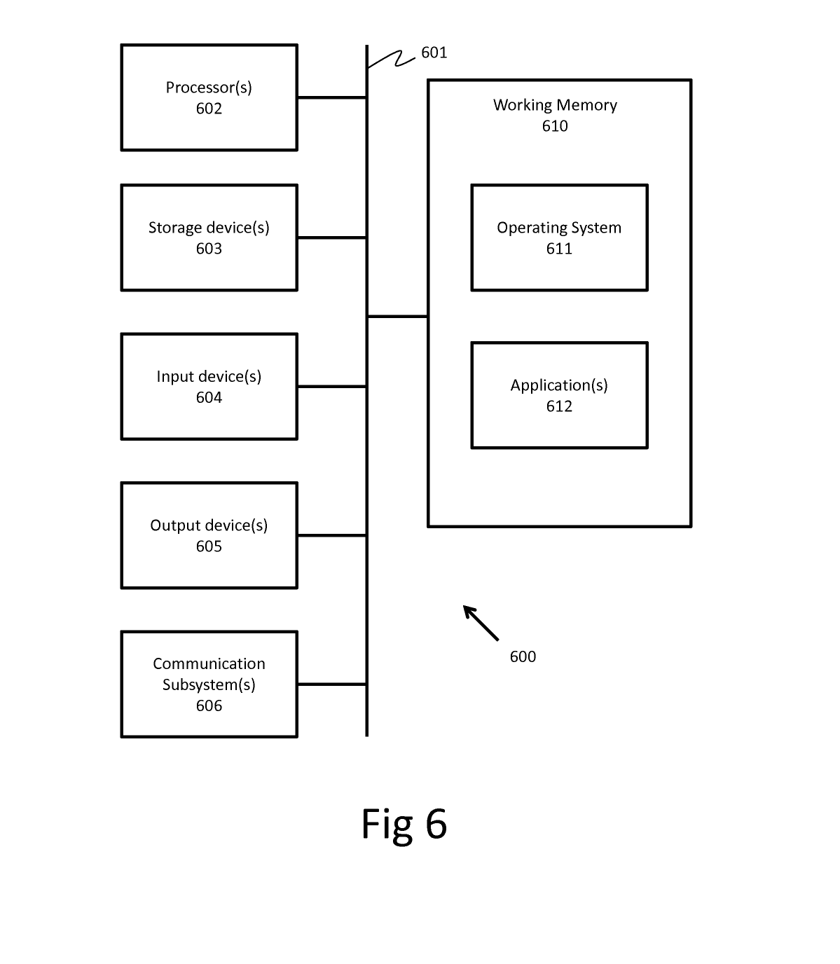

FIG. 6 shows a schematic illustration of one embodiment of a computer system that can perform the methods of the described embodiment. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. The computer system 600 is shown comprising hardware elements that can be electrically coupled via a bus 601 (or may otherwise be in communication, as appropriate). The hardware elements can include one or more processors 602, communication subsystems 606, one or more input devices 604, which can include without limitation a mouse, a keyboard and/or the like; and one or more output devices 605, which can include without limitation a display device, a printer and/or the like. The computer system 600 may further include (and/or be in communication with) one or more storage devices 603. The computer system 600 also can comprise software elements, shown as being located within the working memory 610, including an operating system 611 and/or other code, such as one or more application programs 612, which may comprise computer programs of the described embodiments, and/or may be designed to implement methods of the described embodiments of a computer-method of the embodiments as described herein.

At least some embodiments include a program storage device readable by a machine, tangibly embodying a program of instructions executable by the machine to perform a computer-executable method of an embodiment of the present invention.

Although specific embodiments have been described and illustrated, the embodiments are not to be limited to the specific forms or arrangements of parts so described and illustrated.

1. A computer-implemented method for managing transactions using a transaction manager process in a network comprising at least one first source of transactions and a plurality of second sources of transactions, wherein the method comprises steps for:
a) receiving from each of the plurality of second sources of transactions representing competing services a set of new tentative transactions adapted to replace an original actual transaction originated from the first source of transactions, wherein at least one data attribute of the at least one transaction of the plurality of new tentative transactions is associable with a data attribute of the original transaction,
b) verifying the data of the new tentative transactions using at least one data verification rule of the transaction manager process,
c) establishing at least one threshold event, which must occur in order for the transaction manager to atomically change the status of the a set of new tentative transactions received from one of the second sources into a set of new actual transactions,
d) receiving from at least one first source of transactions data triggering the at least one threshold event,
e) atomically changing the statuses of the transactions, and
f) sending at least one of the new actual transactions to the at least one first source of transactions.

2. A method according to claim 1, wherein the method comprises the step of the transaction manager (100) to sign data of at least one transaction received from at least one second source of transactions.

3. A method according to claim 1, wherein the second source of transactions is adapted to receive transactions from the first source of transactions based on a data sharing agreement established between a user representing the first source of transactions and a user representing the second source of transactions.

4. A method according to claim 1, wherein the transaction is an invoice and one of the new actual transactions is a credit invoice of the original invoice.

5. A method according to claim 1, wherein the second source of transactions is an application service adapted to provide a service based on the original actual transaction received from the first source of transactions.

6. A method according to claim 5, wherein the application service is an invoice financing service comprising means for producing tentative transactions that are subject to approval of the first source of transactions.

7. A method according to claim 1, wherein the step of verifying the data of the new tentative transactions using at least one data verification rule of the transaction manager process comprises selecting at least one of the applicable verification rules based on the preferences and/or capabilities of the at least one first source of transactions.

8. A computer system, comprising one or more processors and memory having instructions stored thereon, the instructions, if executed by the one or more processors, cause the system to perform operations for managing transactions using a transaction manager process in a network comprising at least one first source of transactions and a plurality of second sources of transactions, wherein the operations comprise:
a) receiving from each of a plurality of second sources of transactions representing competing services a set of new tentative transactions adapted to replace an original actual transaction originated from the first source of transactions, wherein at least one data attribute of the at least one transaction of the plurality of new tentative transactions is associable with a data attribute of the original transaction,
b) verifying the data of the new tentative transactions using at least one data verification rule of the transaction manager process,
c) establishing at least one threshold event, which must occur in order for the transaction manager to atomically change the status of the set of new tentative transactions received from one of the second sources into the set of new actual transactions,
d) receiving from at least one first source data triggering the at least one threshold event,
e) atomically changing the statuses of the transactions, and
f) sending at least one of the new actual transactions to the at least one first source.

9. A computer-program product having instructions stored thereon, the instructions, when executed by one or more processors, cause the processors to perform operations for managing transactions in a transaction manager process in a network comprising at least one first source of transactions and a plurality of second sources of transactions, wherein the operations comprise:
a) receiving from each of a plurality of second sources of transactions representing competing services a set of new tentative transaction adapted to replace an original actual transaction originated from the first source of transactions, wherein at least one data attribute of the at least one transaction of the plurality of new tentative transactions is associable with a data attribute of the original transaction,
b) verifying the data of the new tentative transactions using at least one data verification rule of the transaction manager process,
c) establishing at least one threshold event, which must occur in order for the transaction manager to atomically change the status of the set of new tentative transactions received from one of the second sources into the set of new actual transactions,
d) receiving from at least one first source data triggering the at least one threshold event,
e) atomically changing the statuses of the transactions, and
f) sending at least one of the new actual transactions to the at least one first source.
